(19) United States
(12) Patent Application Publication
(10) Pub. No.: US 2025/0276592 A1
(43) Pub. Date: Sep. 4, 2025

(54) BATTERY CHARGER ENCLOSURE HAVING RETRACTING MECHANISM

(71) Applicant: Tucker Innovations, LLC, Kaysville, UT (US)

(72) Inventor: Brian Tucker, Kaysville, UT (US)

(21) Appl. No.: 18/894,501

(22) Filed: Sep. 24, 2024

Related U.S. Application Data
(60) Provisional application No. 63/559,867, filed on Feb. 29, 2024.

(51) Int. Cl. B60L 53/18; B60L 53/30

(52) U.S. Cl. CPC B60L 53/18; B60L 53/30

(57) ABSTRACT

Enclosures for battery chargers for individual EVs are provided. An enclosure can be configured to house a battery charger and can be secured to a wall near an outlet or other source of electricity. The enclosure can include a retracting mechanism such as a badge reel that can be secured to the charging cable of the battery charger to prevent the charging cable from contacting the floor when not connected to the individual EV. A coupler may be secured to the retracting mechanism and may be configured to easily couple to charging cables of various diameters in a non-slip manner.

### CROSS-REFERENCE TO RELATED APPLICATIONS

This application claims the benefit of U.S. Provisional Appl. No. 63/559,867.

### BACKGROUND

Electric bikes, scooters, dirt bikes, motorcycles, and other similar small electric vehicles (hereinafter generally referred to as “individual EVs”) have recently become common. These individuals EVs are oftentimes parked in a garage or similar structure where they may be connected to a battery charger. It is typical for the battery chargers to be left hanging from the outlet and onto the floor where they can be stepped on or exposed to dirt and water. It is also common for the battery chargers to be misplaced. These issues are especially prevalent when a child or youth rides an individual EV.

Additional difficulties exist when a family or location has multiple individual EVs that are all parked near the same outlet. Even if an effort is made to organize the battery chargers, it is typically inevitable that the battery chargers will end up on the floor or misplaced.

### BRIEF SUMMARY

The present disclosure is directed to enclosures for battery chargers for individual EVs. An enclosure can be configured to house a battery charger and can be secured to a wall near an outlet or other source of electricity. The enclosure can include a retracting mechanism such as a badge reel that can be secured to the charging cable of the battery charger to prevent the charging cable from contacting the floor when not plugged into the individual EV. A coupler may be secured to the retracting mechanism and may be configured to easily connect to charging cables of various diameters in a non-slip manner.

In some embodiments, an enclosure for a battery charger for an individual EV includes a base that is configured to support an adapter of the battery charger and a badge reel that is supported by the base. The badge reel is configured to couple to a charging cable of the battery charger such that the charging cable is retracted when not plugged into the individual EV.

In some embodiments, the base may form an enclosed area in which the adapter is supported and the enclosure may include a lid that covers the enclosed area.

In some embodiments, the enclosure may include a coupler that is connected to a retractor of the badge reel and configured to receive the charging cable.

In some embodiments, the coupler forms a charging cable channel with one or more curves or bends.

In some embodiments, the charging cable channel is S-shaped.

In some embodiments, the base includes a retractor opening through which a retractor of the badge reel extends out from the base.

In some embodiments, the retractor opening is formed through a floor of the base.

In some embodiments, the floor of the base forms a charging cable opening through which the charging cable extends out from the enclosure.

In some embodiments, the base includes one or more cord notches.

In some embodiments, the base includes a cartridge in which the badge reel is housed.

In some embodiments, the base includes a cartridge housing that receives the cartridge.

In some embodiments, a retractor opening is formed within the cartridge housing.

In some embodiments, a charging cable opening is formed adjacent to the cartridge housing.

In some embodiments, the enclosure may include a coupler secured to a retractor of the badge reel, the coupler including a main housing and a cover and forming a charging cable channel through which the charging cable is routed.

In some embodiments, the cover is rotatable relative to the main body.

In some embodiments, the charging cable channel includes two or more curves or bends.

In some embodiments, a coupler for securing a charging cable of an individual EV to a retractor may include a main body and a cover that form a charging cable channel having one or more curves or bends. The charging cable channel includes an ingress and an egress for the charging cable.

In some embodiments, the charging cable channel is S-shaped.

In some embodiments, an enclosure for a battery charger for an individual EV may include a base forming an enclosed area configured to receive an adapter of the battery charger. The base forms a charging cable opening and a retractor opening. The enclosure also includes a retracting mechanism having a retractor that extends out of the enclosure through the retractor opening.

In some embodiments, the enclosure may include a coupler that is secured to the retractor. The coupler forms a charging cable channel through which a charging cable can be routed when the charging cable extends out of the enclosure through the charging cable opening.

This summary is provided to introduce a selection of concepts in a simplified form that are further described below in the Detailed Description. This Summary is not intended to identify key features or essential features of the claimed subject matter.

### BRIEF DESCRIPTION OF THE DRAWINGS

In order to describe the manner in which the above-recited and other advantages and features can be obtained, a more particular description will be rendered by reference to specific embodiments which are illustrated in the appended drawings. These drawings depict only typical embodiments and are not therefore to be considered to be limiting.

FIGS. 1A and 1B illustrate an example of an enclosure configured in accordance with one or more embodiments of the present disclosure.

FIGS. 2A-2E illustrate a base of the enclosure of FIGS. 1A and 1B.

FIGS. 3A and 3B illustrate a lid of the enclosure of FIGS. 1A and 1B.

FIG. 4 is a cross-sectional view of the enclosure of FIGS. 1A and 1B.

FIGS. 5A-5D illustrate a coupler that is configured in accordance with one or more embodiments of the present disclosure.

FIGS. 6A-6D provide an example of how an enclosure configured in accordance with one or more embodiments of the present disclosure may be used.

FIG. 7 provides an example of how multiple enclosures may be interconnected.

### DETAILED DESCRIPTION

In this specification and the claims, the term “battery charger” will be used to represent the entire charging assembly necessary to plug in an individual EV. A battery charger includes an “adapter” and a “charging cable.” The adapter is the typically rectangular portion of the battery charger that typically converts AC voltage to DC voltage. The charging cable should be construed as the cable that plugs into the individual EV. A battery charger may also include a “cord” which should be construed as the cable that plugs into an outlet. However, some battery chargers have an adapter into which the plug is integrated and therefore such battery chargers do not have a cord.

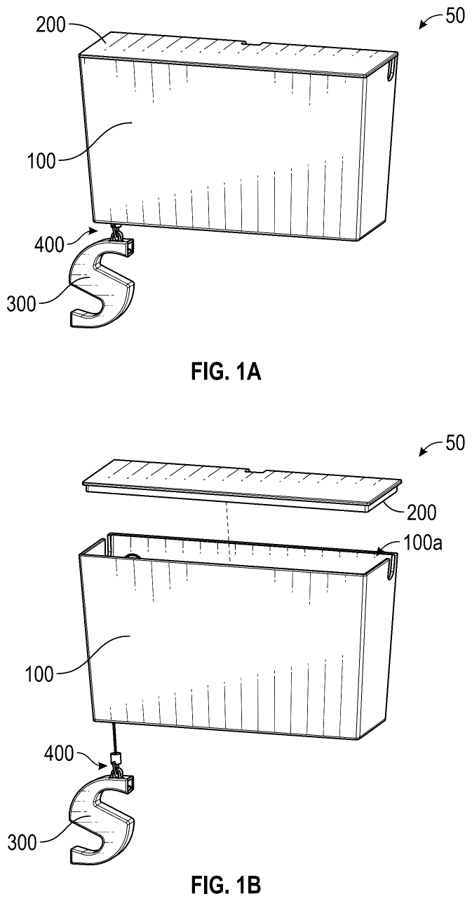

FIGS. 1A and 1B provide an example of an enclosure 50 that is configured in accordance with one or more embodiments of the present disclosure. Enclosure 50 includes a base 100 and a lid 200 that couple together to cause enclosure 50 to have a generally rectangular shape. However, an enclosure could be configured in any other suitable shape. Base 100 forms an enclosed area 100a in which the adapter of a battery charger may be placed. Lid 200 can be configured to at least partially cover enclosed area 100a to prevent removal of the battery charger from enclosure 50.

Enclosure 50 also includes a coupler 300 and a retracting mechanism 400. Retracting mechanism 400 may be housed within or otherwise supported by base 100 and/or lid 200. Coupler 300 is connected to retracting mechanism 400 and is configured to couple to a charging cable as described in detail below.

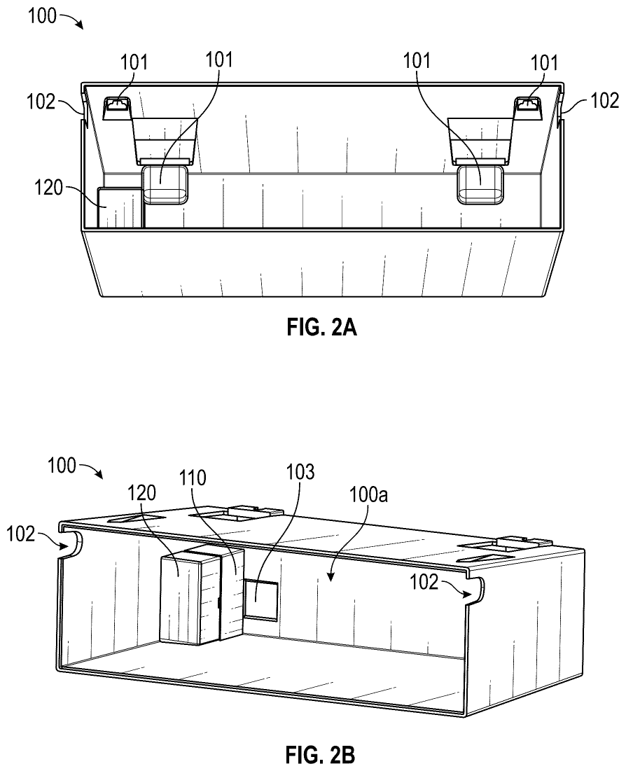

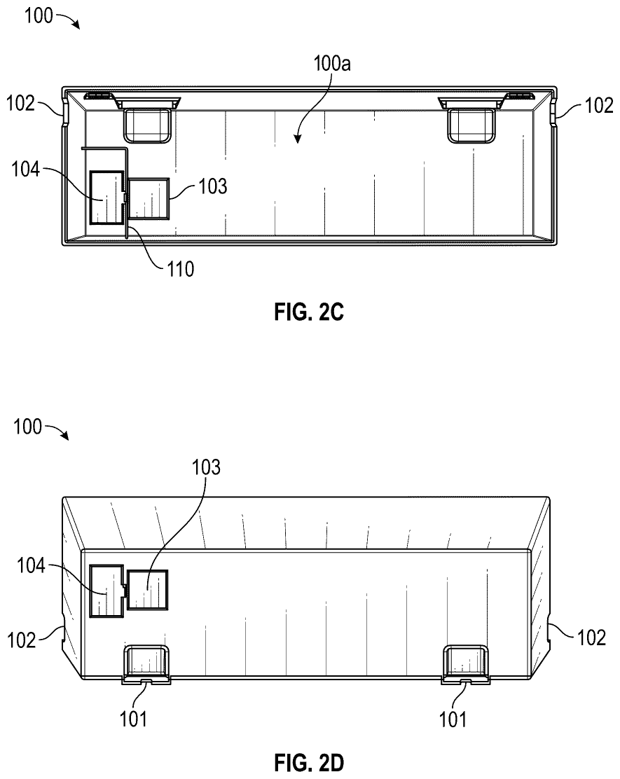

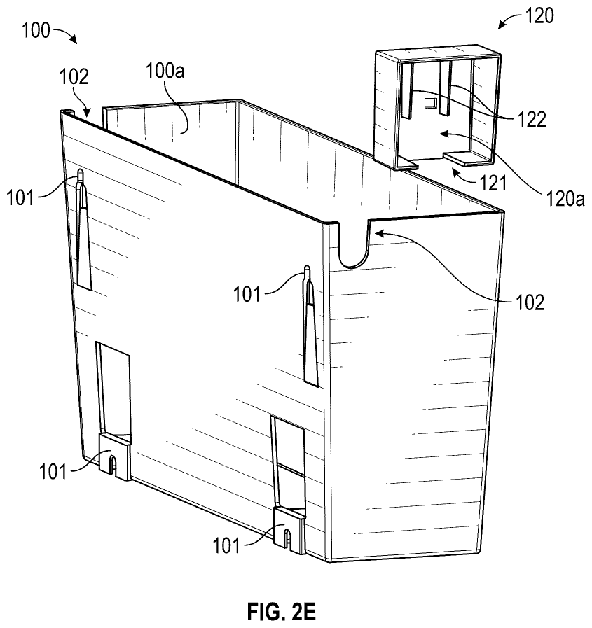

FIGS. 2A-2E are various views of base 100 in isolation. Base 100 may include walls and a floor that form enclosed area 100a. Enclosed area 100a may be shaped and sized to receive an adapter of a battery charger. In some embodiments, a wall of base 100 may include one or more openings 101 (e.g., screw holes) for mounting base 100 to a wall. In some embodiments, base 100 may be configured to be secured to a wall via an adhesive, hook and loop, or another fastening mechanism.

A cord notch 102 could be formed in the upper edge of one or more of the walls of base 100. For example, in the depicted embodiments, cord notches 102 are formed in each side wall. Each cord notch 102 can be configured to accommodate the cord of the battery charger, the charging cable of the battery charger, or an extension cord when lid 200 is placed on base 100.

In some embodiments, including the depicted embodiments, base 100 includes a cartridge housing 110 and a cartridge 120 that is securable within cartridge housing 110. Cartridge 120 is configured to house retracting mechanism 400. For example, cartridge 120 may form an enclosed area 120a that is shaped and sized to receive the body of a badge reel which may be round, square or another shape. Opposing ribs 122 may extend into enclosed area 120a and may be configured to be positioned on opposing sides of a clip on the back of the badge reel body to prevent the badge reel body from rotating within cartridge 120. A bottom of cartridge 120 may form a cartridge opening 121 through which the retractor of the badge reel extends. When cartridge 120 is inserted into cartridge housing 110, the opening to enclosed area 120a can face the wall of base 100 to thereby secure the badge reel within cartridge 120. In other embodiments, however, cartridge 120 may be omitted and retractor 400 may be housed directly in cartridge housing 110. Accordingly, cartridge housing 110 could have a variety of shapes and/or configurations for receiving/securing retractor 400.

A retractor opening 104 may be formed in the floor of base 100 within cartridge housing 110 and, in embodiments that employ cartridge 120, may align with cartridge opening 121 to allow the retractor of the badge reel to extend from base 100. A charging cable opening 103 may also be formed in the floor of base 100 to allow the charging cable of the battery charger to extend from base 100 when its adapter is contained in enclosed area 100a. Charging cable opening 103 may be positioned adjacent cartridge housing 110 so that the charging cable will be positioned adjacent to the retractor of the badge reel. However, in some embodiments, charging cable opening 103 could be positioned anywhere in the floor or a wall of base 100.

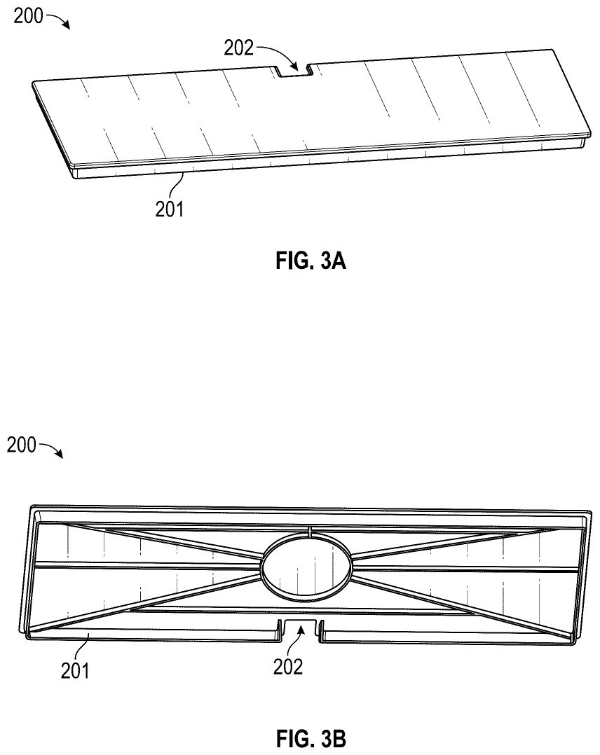

FIGS. 3A and 3B illustrate lid 200 in isolation. Lid 200 may include a lip 201 that is shaped and sized to insert tightly within base 100. Lid 200 may also include a cord notch 202 that may be centered along a rear edge. Like cord notches 102, cord notch 202 can allow the cord, an extension cord, or the charging cable to extend into enclosed area 100a when lid 200 is in place on base 100.

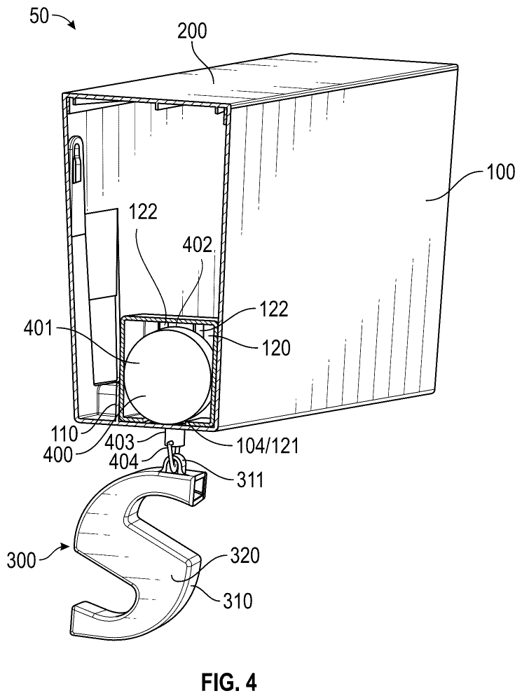

FIG. 4 is a cross-sectional view of enclosure 50 and provides an example of how retracting mechanism 400 can be housed within base 100. In this example, retracting mechanism 400 is in the form of a badge reel having a body 401, a clip 402 (not visible), a retractor 403, and a coupling element 404. Body 401 is oriented to position clip 402 between ribs 122 and to position retractor 403 downward. In some embodiments, cartridge 120 may have a height that is greater than the vertical dimension of body 401 to allow body 401 to slide within cartridge 120. This ability of body 401 to slide within cartridge 120 allows body 401 to absorb the force caused when retractor 403 retracts to prevent cartridge 120 from sliding out from cartridge housing 110.

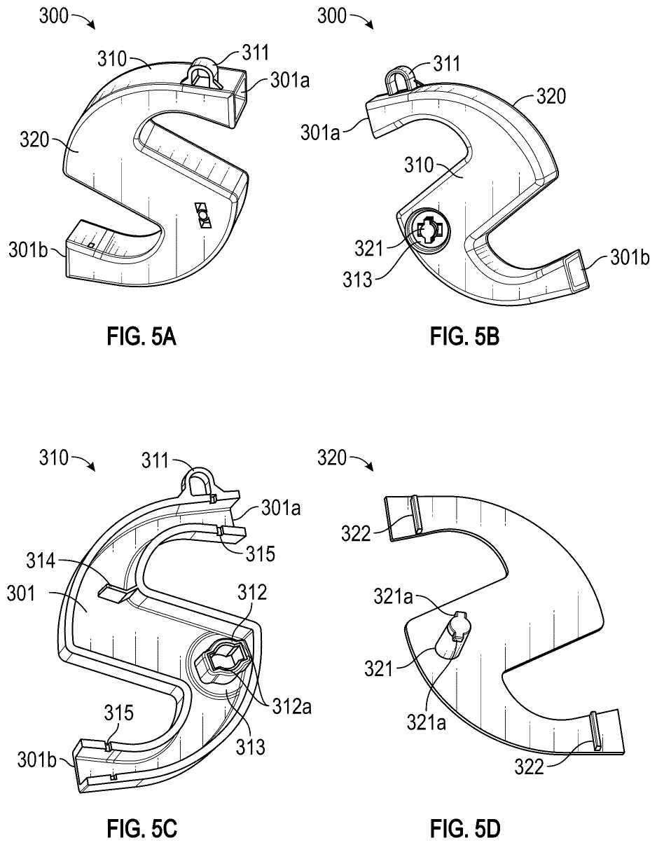

FIGS. 5A and 5B are front and rear views respectively of coupler 300. Coupler 300 includes a main body 310 and a cover 320 that is secured to main body 310. FIG. 5C is a front view of main body 310 in isolation. FIG. 5D is a rear view of cover 320 in isolation.

Cover 300 forms a charging cable channel 301 which includes an ingress 301a and an egress 301b. In some embodiments, including the depicted embodiments, main body 310 may be recessed to form this charging cable channel 301. Charging cable channel 301 may include one or more curves or bends which create friction points for preventing a charging cable routed through charging cable channel 301 from sliding relative to charging cable channel 301 when the charging cable is pulled. In the depicted embodiments, cover 300 is shaped like an S which creates two curves/bends in charging cable channel 301. However, a cover could include a single curve/bend or more than two curves/bends in some embodiments. In some embodiments, one or more tabs 314 could be formed within charging cable channel 301 to increase the degree of the curve/bend and/or the friction on the charging cable.

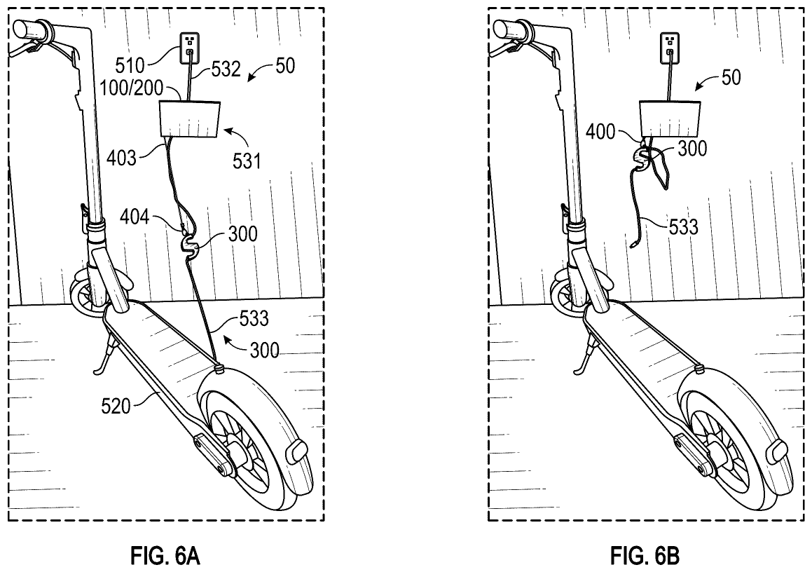

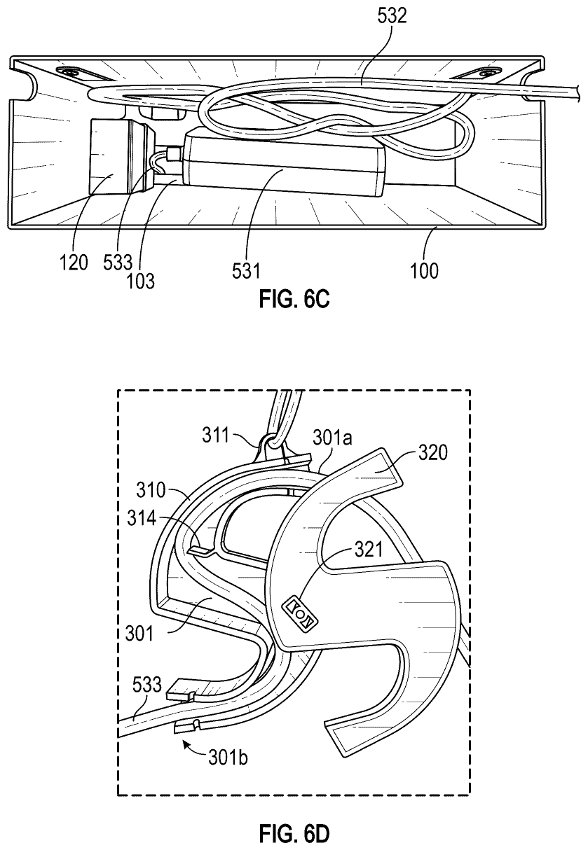

The S-shaped configuration of the depicted embodiments of cover 300 provides the added benefit of preventing the charging cable from bending too much (see e.g., FIG. 6D). In particular, the S-shape with the widened middle section between the curves ensures that the bend/curve radius of the charging cable is maximized to prevent damage to the conductors while still providing sufficient friction to prevent the charging cable from sliding within charging cable channel 301.

In some embodiments, main body 310 and cover 320 can be configured to enable cover 320 to be rotated relative to main body 310. For example, in the depicted embodiments, main body 310 forms a receiver 312 and cover includes a post 321 that inserts into and rotates within receiver 312. In some embodiments, post 321 may include tabs 321a and receiver 312 may include corresponding notches 312a to accommodate tabs 321a. Accordingly, tabs 321a and notches 312a can be aligned to allow post 321 to be inserted into receiver 312. This alignment can occur when cover 320 does not align with main body 310. In some embodiments, the bottom of main body 310 may include a recess 313 into which tabs 321a may extend and may rotate. As shown in FIG. 5B, this rotation causes tabs 321a to interlock with main body 310 to prevent cover 320 from being separated from main body 310, particularly when cover 320 is aligned with main body (i.e., while cover is in use).

In some embodiments, cover 320 can include ribs 322 that insert into cutouts 314 in main body 310 to prevent the unintentional rotation of cover 320 relative to main body 310. In some embodiments, ribs 322 and cutouts 314 may be positioned towards ingress 301a and egress 301b to minimize flexing of cover 320 relative to main body 310. In such embodiments, cover 320 can be rotated relative to main body (e.g., to allow the charging cable to be removed) by first lifting the ends of cover 320 to remove ribs 322 from cutouts 314 (see, e.g., FIG. 6D).

Main body 310, or possibly cover 320, may form a coupling structure 311 by which cover 300 is secured to retracting mechanism 400. For example, coupling structure 311 could be a loop structure (e.g., as shown), a cutout, a lip, a magnet, etc.

FIGS. 6A-6D provide an example of how enclosure 50 may be used. In this example, enclosure 50 is mounted to a wall below an outlet 510. An adapter 531 of a battery charger for a scooter 520 is housed within enclosure 50 with its cord 532 routed out through cord notch 202 and plugged into outlet 510 and its charging cable 533 extending out through charging cable opening 103. Charging cable 533 has been routed through coupler 300 which is connected to retracting mechanism 400. In FIG. 6A, charging cable 533 is plugged into scooter 520 such that retractor 403 is extended. In FIG. 6B, charging cable 533 has been unplugged and retractor 403 has been retracted. Because coupler 300 is fixed to charging cable 533, charging cable 533 is automatically retracted and held off the floor.

As can be seen, enclosure 50 organizes the battery charger and simplifies the process of plugging in and unplugging the charging cable. Enclosure 50 can also incentivize riders to park their individual EVs in the desired location. For example, if a father wants his children to park their scooters along the garage wall, enclosure 50 can require them to do so if the scooters need to be plugged in. Enclosure 50 can therefore greatly enhance a parent's efforts to keep a garage organized. Furthermore, in some embodiments, enclosure 50 may be sized to accommodate more than an adapter within enclosed area 100a. For example, many individual EVs require frequent maintenance using small and/or specialized tools (e.g., a hex wrench, a tire stem extension, etc.). Such tools may be stored in enclosure 50 where they will be easily accessible when needed.

In some embodiments, base 100 may include one or more hooks or other attachment structures to allow an individual to store items by hanging them from base 100. For example, a hook could be formed on the side of the base opposite cartridge 120 to allow a lock, bag, or other item to be stored when not in use.

In some embodiments, retracting mechanism 400 may be a retracting spool rather than a badge reel. In such cases, the charging cable can be wrapped around the retracting spool such that only its end extends out through charging cable opening 103 when retracted. In other words, in embodiments in which a retracting spool is provided, the charging cable may be fully retracted into enclosure 50 as opposed to hanging beneath enclosure 50.

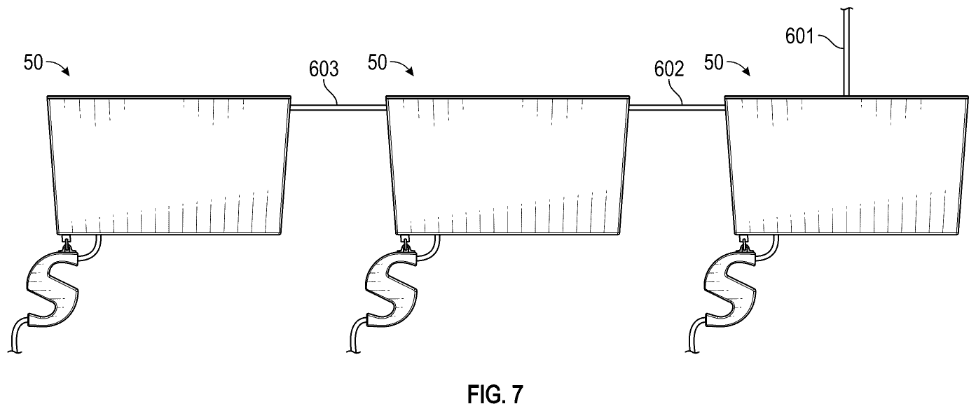

In some embodiments, cord notches 102 can facilitate daisy chain connections between adjacent enclosures 50. For example, as represented in FIG. 7, a family having multiple electric scooters may mount multiple enclosures 50 on a garage wall where they desire that the scooters be parked for charging. Then, to avoid having to connect all the battery chargers separately to an outlet or power strip, a first extension cord 601 could be routed into one of enclosures 50 (e.g., via cord notch 202 or via one of cord notches 102). This first extension cord 601 could include two sockets into which the cord of the battery charger in the enclosure 50 may be plugged in. A second extension cord 602 could be plugged into the other socket and routed out through cord notch 102 and then in through cord notch 102 of an adjacent enclosure 50. The second extension cord 602 could also include two sockets to allow the cord of the battery charger in that enclosure and another extension cord 603 (or the cord of another battery charger) to be plugged in. This type of daisy chain connection between adjacent enclosures 50 could be repeated as necessary to provide power inside all enclosures 50 via the first extension cord 601.

What is claimed:

1. An enclosure for a battery charger for an individual electric vehicle (EV) comprising:
a base that is configured to support an adapter of the battery charger; and
a badge reel supported by the base, the badge reel being configured to couple to a charging cable of the battery charger such that the charging cable is retracted when not plugged into the individual EV.

2. The enclosure of claim 1, wherein the base forms an enclosed area in which the adapter is supported, the enclosure further comprising:
a lid that covers the enclosed area.

3. The enclosure of claim 1, further comprising:
a coupler that is connected to a retractor of the badge reel and configured to receive the charging cable.

4. The enclosure of claim 3, wherein the coupler forms a charging cable channel with one or more curves or bends.

5. The enclosure of claim 3, wherein the charging cable channel is S-shaped.

6. The enclosure of claim 1, wherein the base includes a retractor opening through which a retractor of the badge reel extends out from the base.

7. The enclosure of claim 6, wherein the retractor opening is formed through a floor of the base.

8. The enclosure of claim 7, wherein the floor of the base forms a charging cable opening through which the charging cable extends out from the enclosure.

9. The enclosure of claim 1, wherein the base includes one or more cord notches.

10. The enclosure of claim 1, wherein the base includes a cartridge in which the badge reel is housed.

11. The enclosure of claim 10, wherein the base includes a cartridge housing that receives the cartridge.

12. The enclosure of claim 11, wherein a retractor opening is formed within the cartridge housing.

13. The enclosure of claim 12, wherein a charging cable opening is formed adjacent to the cartridge housing.

14. The enclosure of claim 1, further comprising:
a coupler secured to a retractor of the badge reel, the coupler including a main housing and a cover and forming a charging cable channel through which the charging cable is routed.

15. The enclosure of claim 14, wherein the cover is rotatable relative to the main body.

16. The enclosure of claim 14, wherein the charging cable channel includes two or more curves or bends.

17. A coupler for securing a charging cable of an individual EV to a retractor, the coupler comprising:
a main body and a cover that form a charging cable channel having one or more curves or bends, the charging cable channel including an ingress and an egress for the charging cable.

18. The coupler of claim 17, wherein the charging cable channel is S-shaped.

19. An enclosure for a battery charger for an individual EV comprising:
a base forming an enclosed area configured to receive an adapter of the battery charger, the base forming a charging cable opening and a retractor opening; and
a retracting mechanism having a retractor that extends out of the enclosure through the retractor opening.

20. The enclosure of claim 19, further comprising:
a coupler that is secured to the retractor, the coupler forming a charging cable channel through which a charging cable can be routed when the charging cable extends out of the enclosure through the charging cable opening.
